(19) United States
(12) Patent Application Publication
(10) Pub. No.: US 2011/0240684 A1
(43) Pub. Date: Oct. 6, 2011

(54) Beverage Dispensing Spigot

(76) Inventor: Robert Craig McSavaney, Boulder, CO (US)

(21) Appl. No.: 13/035,905

(22) Filed: Feb. 25, 2011

Related U.S. Application Data
(60) Provisional application No. 61/308,010, filed on Feb. 25, 2010.

(51) Int. Cl. F16K 7/04; B67D 3/02; F16K 31/00

(52) U.S. Cl. 222/517; 251/7; 251/9

(57) ABSTRACT

The beverage dispensing spigot comprises a rigid first conduit that communicates with the interior of the container, pipe, or manifold to which the spigot is attached. The first conduit communicates with a flexible second conduit internal to the body of the spigot. The flow of liquid through the flexible second conduit is regulated by the position of two opposing flanges, one of which is attached to the rigid body of the spigot and the other to a moveable actuator lever. The actuator lever is biased to a closed position by an elastomeric closure, and can be pushed to the open position by a user pushing on the portion of the lever that extends below the spigot. When a user pushes a cup or personal beverage container against the actuator lever, the moveable flange separates from the fixed flange, allowing the flexible second conduit to open and liquid to flow into a rigid third conduit that smoothes and straightens the flow and directs it into the cup or personal beverage container.

### CROSS-REFERENCE TO RELATED APPLICATIONS

The present invention claims the benefit of Provisional U.S. Patent Application No. 61/308,010 filed on Feb. 25, 2010. Furthermore, the details of Application No. 61/308,010 are incorporated by reference into the present application in their entirety and for all proper purposes.

### FEDERALLY SPONSORED RESEARCH

Not applicable.

### SEQUENCE LISTING OR PROGRAM

Not applicable.

### BACKGROUND

1. Field

This application relates to beverage dispensing spigots. In particular, but not by way of limitation, the present application relates to an improved beverage dispensing spigot adapted for use on beverage coolers and beverage dispensing systems.

2. Prior Art

Spigots are known for use in coolers, insulated jugs, cartons and other liquid containers. Such spigots dispense the liquid by allowing gravity to drain the liquid from the container when the spigot is opened. Typically, the spigots include a button that moves a valve element away from a valve seat to open a conduit to allow the liquid to drain from the container. The valve element may be biased to the closed position by a spring such as an elastomeric diaphragm. One such spigot is shown in U.S. Pat. No. 4,452,425 issued on Jun. 5, 1984 to Lucking. Another such spigot is shown in U.S. Pat. No. 4,742,851 issued on May 10, 1988 to Lundblade. Yet another such spigot is shown in U.S. Pat. No. 7,455,281 issued on Nov. 25, 2008 to Craft.

While such spigots are known, the known spigots suffer from at least one of a number of shortcomings. One such shortcoming is a low maximum flow rate. Most known spigots dispense fluids at a maximum rate of approximately 2 ounces per second when dispensing from a completely full cooler. While this flow rate is adequate for applications where the user is not in a hurry or is filling a relatively small cup or personal beverage container, the slow dispensing rate of current spigots severely limits their utility when users are in a hurry, such as when competing in a sporting event, or when they want to fill larger cups or personal beverage containers.

Another shortcoming is that the user cannot operate the spigot with the same hand they are using to hold the cup or personal beverage container they intend to fill. To dispense liquids from a common cooler with a known spigot, the cooler is typically placed on a table with the spigot extending slightly beyond the edge of the table, and a user holds their cup or personal beverage container below the spigot with one hand while using the other hand to operate the spigot. While there are situations in which users do not mind using both of their hands to fill their cup or personal beverage container, the utility of known spigots is severely limited in situations where users are carrying an item in one of their hands, such as at a picnic, or in situations where users need to rapidly fill a large number of cups or personal beverage containers, such as at a sporting event.

Another shortcoming with known spigots is that they are very difficult to thoroughly clean, disinfect, and dry. Because of the compact size of known spigots and the complexity of their closure mechanisms, their internal geometries are complicated and irregular, resulting in the existence small voids and inaccessible reservoirs where liquid resides after a cooler is completely emptied. Often the beverages that are dispensed from insulated coolers are sweetened beverages and sports drinks similar to Gatorade®. The residual sweetened beverage that resides in the voids and reservoirs of known spigots often forms mold and mildew that cannot be removed or disinfected due to the lack of access to the inner portions of the spigot.

Another shortcoming with known spigots is that many people find them difficult to operate. For example, children and the elderly often do not have sufficient strength to overcome the resistance of the spring member without difficulty. People filling large personal beverage containers, or those who need to fill a large number of cups or containers, quickly tire of depressing the small push-type-button against the relatively strong biasing spring. Finally, because of the relatively small size of the surfaces of known spigots which must be depressed in order to operate them, people with physical or neuromuscular disorders can also have difficulty operating known spigots.

There is a need for a spigot that has an improved flow volume, can be actuated using the same hand that a person uses to hold the personal beverage container being filled, has easily accessible internals so it can be thoroughly cleaned, disinfected, and dried, and is easier to actuate and control for people with smaller or weaker hands.

### SUMMARY

One exemplary embodiment of the present invention that is shown in the drawings is summarized below and more fully described in the Detailed Description section. It is to be understood, however, that there is no intention to limit the invention to the form described in this Summary or in the Detailed Description. One skilled in the art can recognize that there are numerous modifications, equivalents and alternative constructions that fall within the spirit and scope of the invention as expressed in the claims.

The spigot of the invention comprises a rigid first conduit that communicates with the interior of the container, pipe, or manifold to which the spigot is attached. The first conduit communicates with a flexible second conduit internal to the body of the spigot. The flow of liquid through the flexible second conduit is regulated by the position of two opposing flanges, one of which is attached to the rigid body of the spigot and the other to a moveable actuator lever. The actuator lever is biased to a closed position by an elastomeric closure, and can be pushed to the open position by a user pushing on the portion of the lever that extends below the spigot. When a user pushes a cup or personal beverage container against the actuator lever, the moveable flange separates from the fixed flange, allowing the flexible second conduit to open and liquid to flow into a rigid third conduit that smoothes and straightens the flow and directs it into the cup or personal beverage container.

### BRIEF DESCRIPTION OF THE DRAWINGS

FIG. 1 shows a perspective view of one embodiment of the spigot of the present invention.

FIGS. 2A to 2B show right side views of the spigot of FIG. 1 in the closed and open positions, respectively.

FIG. 3 shows a front view of the spigot of FIG. 1.

FIGS. 4A to 4B show vertical section views of the spigot taken along line 4-4 of FIG. 3 in the closed and open positions, respectively.

FIG. 5 shows the spigot of FIG. 1 mounted on a container.

### DETAILED DESCRIPTION

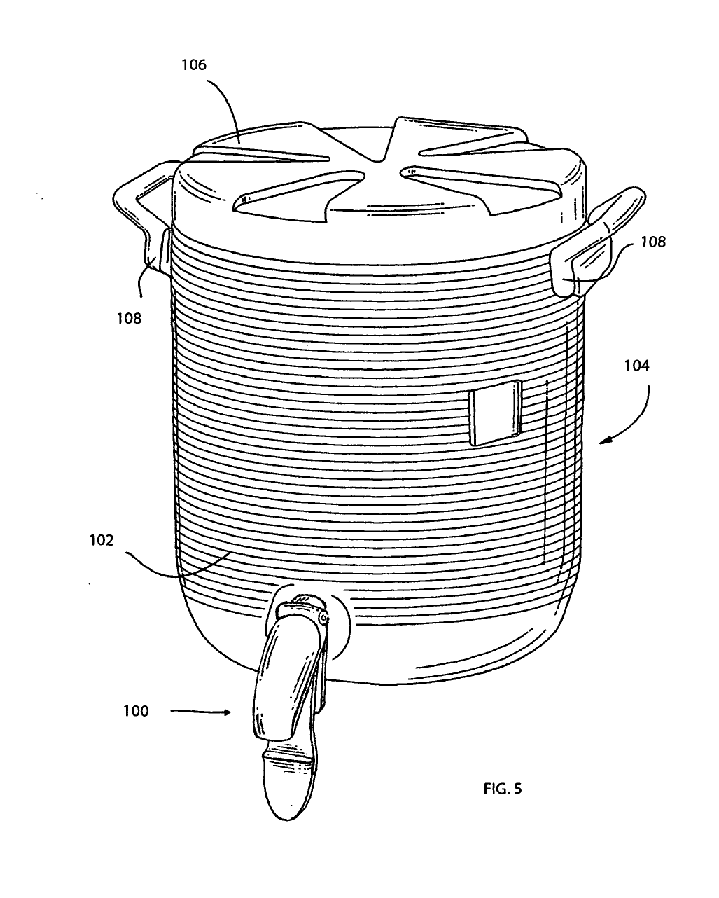

FIG. 5 shows an embodiment of the spigot of the invention generally at 100 mounted to side wall 102 of container 104. In the arrangement illustrated in FIG. 5 container 104 comprises an insulated jug of the type used for storing and dispensing cold liquids such as beverages. The jug may comprise a dual walled insulated construction having a removable top 106 for filling the jug and handles 108 for carrying the jug. While spigot 100 is illustrated on an insulated beverage jug, it is to be understood that container 104 may be any container where dispensing of liquids using spigot 100 is desired including coolers, cartons, bottles, tubs, boxes or the like, or any conduit in fluid flow communication with any such container or reservoir including pipes, tubes, manifolds, hoses or the like.

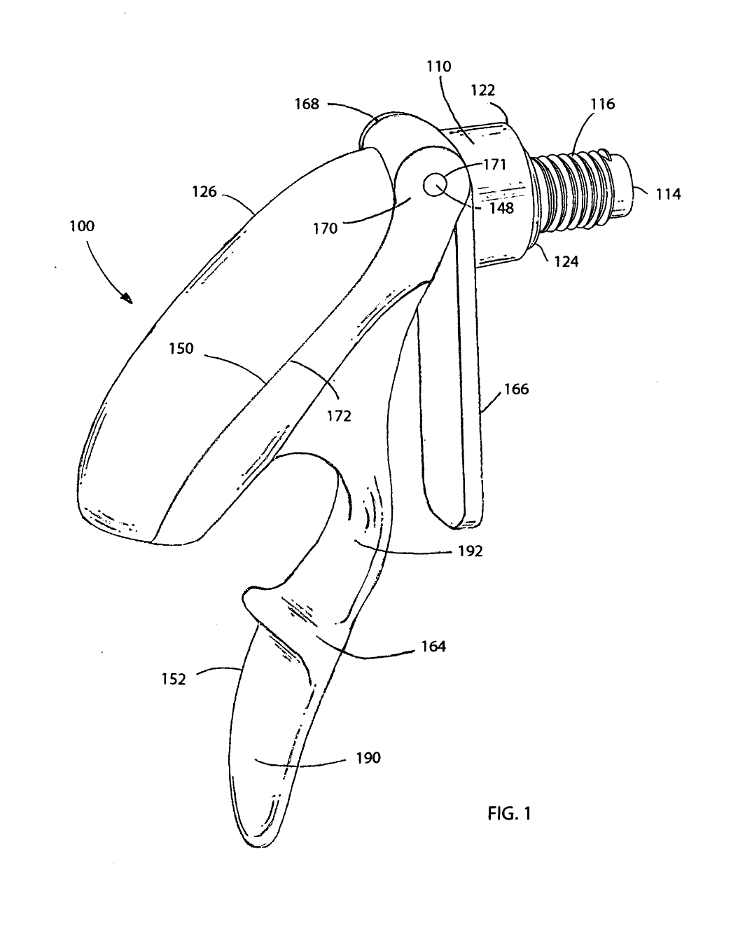

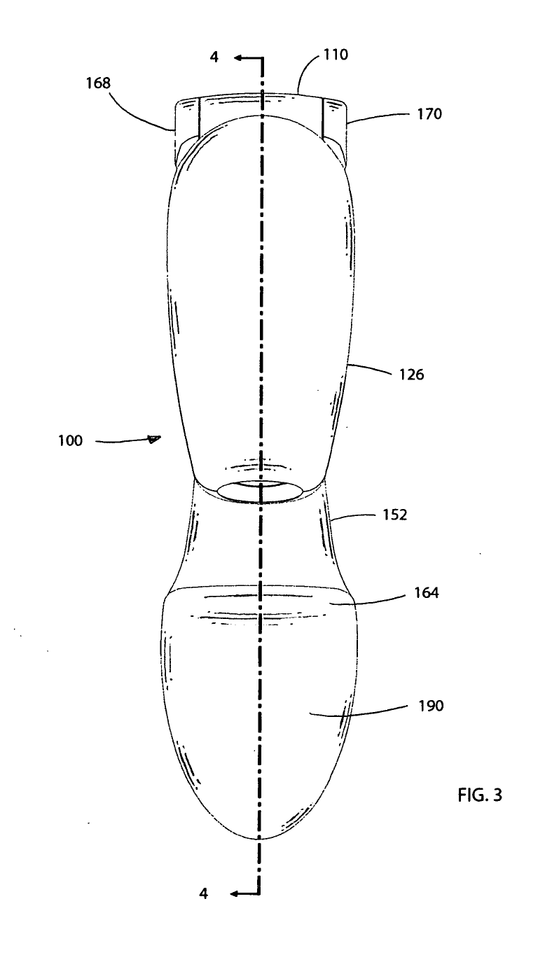

Referring to FIGS. 1 through 4 spigot 100 includes a first conduit 110 having a passageway 112 that is open at its first end 114. Passageway 112 communicates with the interior of container 104 to allow liquid to flow into open end 114 and through passageway 112. Conduit 110 may be mounted to sidewall 102 of container 104. To mount conduit 110 to container 104 external screwthreads 116 are formed on conduit 110. Conduit 110 is inserted through an aperture 118 formed in sidewall 102 such that screwthreads 116 are exposed on the interior of container 104. An internally threaded nut 120 engages screwthreads 116 to trap sidewall 102 between nut 120 and a shoulder 122 formed on conduit 110 when nut 120 is tightened on screwthreads 116. A gasket 124 may be located between nut 120 and sidewall 102 to create a liquid tight seal. In the illustrated embodiment conduit 110 extends substantially perpendicular from sidewall 102. A pin hole 149 extends horizontally through conduit 110 above passageway 112 and forward of shoulder 122, and tab 166 extends vertically down a predetermined distance from conduit 110 originating at a location horizontally behind hole 149.

Conduit 110 is open at its second end 128 at the terminus of a cylindrical sleeve 136 that communicates with a second conduit 130. Conduit 130 is constructed of a flexible, liquid impermeable material such as an elastomer and is formed to have a circular or oval cross section. In one embodiment a first annular projection 134 is located on cylindrical sleeve 136. Conduit 130 is attached to conduit 110 by sliding conduit 130 over cylindrical sleeve 136 and annular projection 134 and then installing first retaining band 132 over conduit 130 to create a liquid tight seal between conduit 130 and cylindrical sleeve 136. Retaining band 132 may be constructed of a flexible material such as an elastomer and installed under tension to apply compressive force against conduit 130, or retaining band 132 may be formed of an elastomeric or non-elastomeric material and mechanically tensioned to apply compressive force against conduit 130. Further, conduit 130 may be attached to cylindrical sleeve 136 by adhesive, by sonic or spin welding, by the use of mechanical fasteners, by other methods or by a combination of such methods.

Conduit 130 is connected to and is in fluid flow communication with third conduit 180. Conduit 180 includes a passageway 188 that is open at its first end 186 where liquid enters the conduit. The opposite end 184 of passageway 188 forms a pour spout where the liquid leaves the spigot. In one embodiment a bracket channel 183 is formed in the exterior of conduit 180. Bracket channel 183 is engaged by bracket arms 163 to attach conduit 180 to actuator lever 152. In one embodiment a third annular projection 144 is located on conduit 180 at first end 186. Conduit 130 is attached to conduit 180 by sliding conduit 130 over conduit 180 and annular projection 144 and then installing second retaining band 146 over conduit 130 to create a liquid tight seal between conduit 130 and conduit 180. Retaining band 146 may be constructed of a flexible material such as an elastomer and installed under tension to apply compressive force against conduit 130, or retaining band 146 may be formed of an elastomeric or non-elastomeric material and mechanically tensioned to apply compressive force against conduit 130. Further, conduit 130 may be attached to conduit 180 by adhesive, by sonic or spin welding, by the use of mechanical fasteners, by other methods or by a combination of such methods. While conduit 130 and conduit 180 are shown as separate parts in the illustrated embodiment, conduit 130 and conduit 180 may be formed as a single continuous part.

Shroud 126 is attached to conduit 110. First flange 138 is formed in shroud 126 and supports first flange contact area 139 such that flange 138 is formed perpendicular to the longitudinal axis of shroud 126 and contact area 139 is coplanar with shroud lip 150 and extends the full internal width of shroud 126. Ledge 140 protrudes perpendicularly from flange 138 towards conduit 110, and second annular projection 141 protrudes from ledge 140 towards shroud 126, such that channel 143 is formed between ledge 140 and shroud 126 and channel opening 145 is formed between annular projection 141 and shroud 126. Channel 143 and channel opening 145 are shaped to accommodate closure element 142 which is inserted into channel 143 through channel opening 145 and retained in channel 143 by annular projection 141. While closure element 142 of the illustrated embodiment is constructed from an elastomeric band, closure element 142 may alternately be constructed from a metal spring, from a plastic spring, from other materials or from a combination of such materials. While shroud 126 and conduit 110 are formed as a single continuous part in the illustrated embodiment, shroud 126 and conduit 110 may be separate parts, wherein shroud 126 may be attached to conduit 110 by adhesive, by the use of mechanical fasteners, by sonic welding, or by other methods or by a combination of such methods.

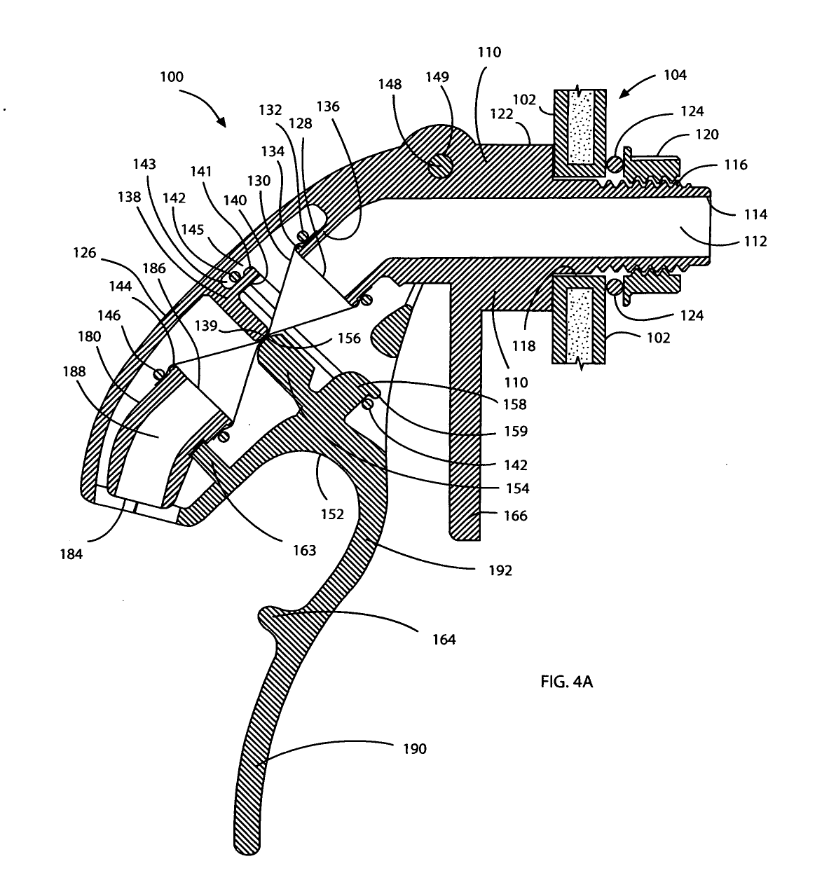

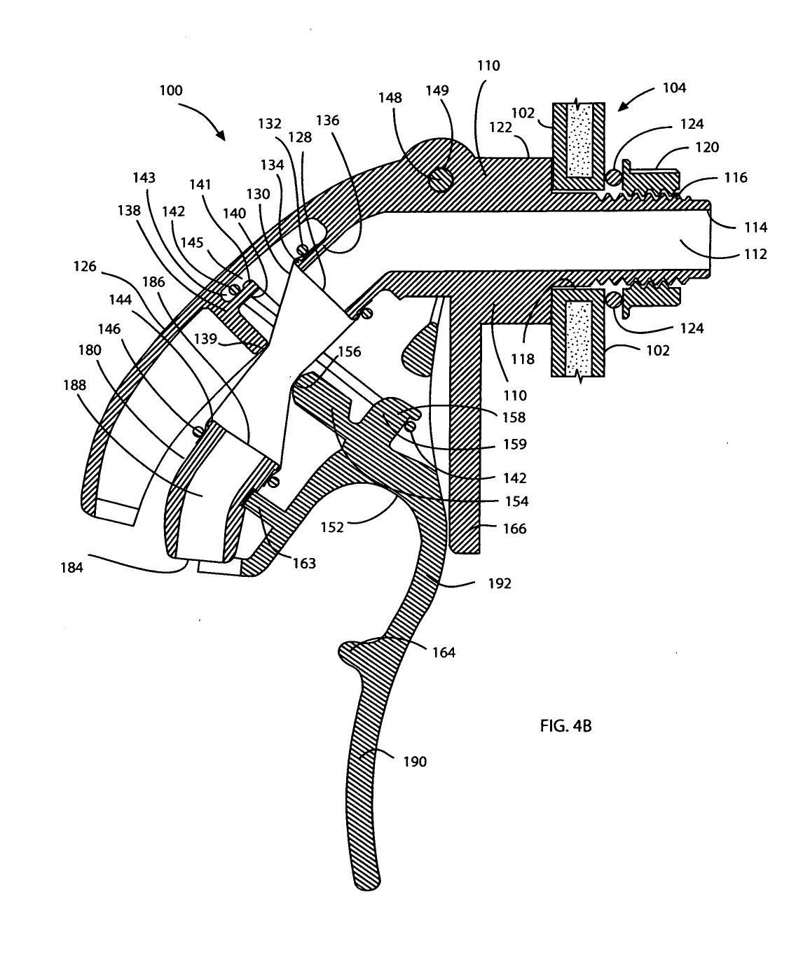

Actuator lever 152 is formed to include a left pivot flange 168 and a right pivot flange 170. Left pivot flange 168 and right pivot flange 170 each include actuator pin hole 171. Actuator lever 152 is pivotally supported on horizontal pin 148 extending through left actuator pin holes 171 and pin hole 149 in conduit 110. A second flange 154 is formed in actuator lever 152 and second flange contact area 156 is formed on flange 154 such that flange contact area 156 is coplanar with actuator lip 172 and extends the full internal width of actuator lever 152. Flange 154 and contact area 156 are further located in actuator lever 152 such that flange 154 is coplanar with flange 138 when actuator lever 152 is in the closed position as shown in FIG. 4A. Closure landing 158 is formed into actuator lever 152, and landing projection 159 is formed into landing 158. Closure landing 158 is shaped to accommodate closure element 142, and landing projection 159 is shaped to retain closure element 142 on landing 158. Indexing ridge 164 is formed in actuator lever 152 at the end of stem 192 and serves to guide the proper placement of beverage containers against the lever. Paddle 190 is formed in actuator lever 152 immediately below indexing ridge 164 and is provided as the intended location for a user to apply an opening force to the actuator lever. Bracket arms 163 are formed in actuator lever 152, and are shaped and positioned to engage bracket channel 183 of conduit 180 to firmly grip and position the conduit so the fluid exiting the spigot will flow parallel to paddle 190 and to ensure conduit 130 will remain in a fixed position and orientation relative to actuator lever 152 during the full range of motion of the actuator lever.

While in the illustrated embodiment closure element 142 biases actuator lever 152 to the closed position, a separate spring or deformable member may be used to bias the actuator lever to the closed position.

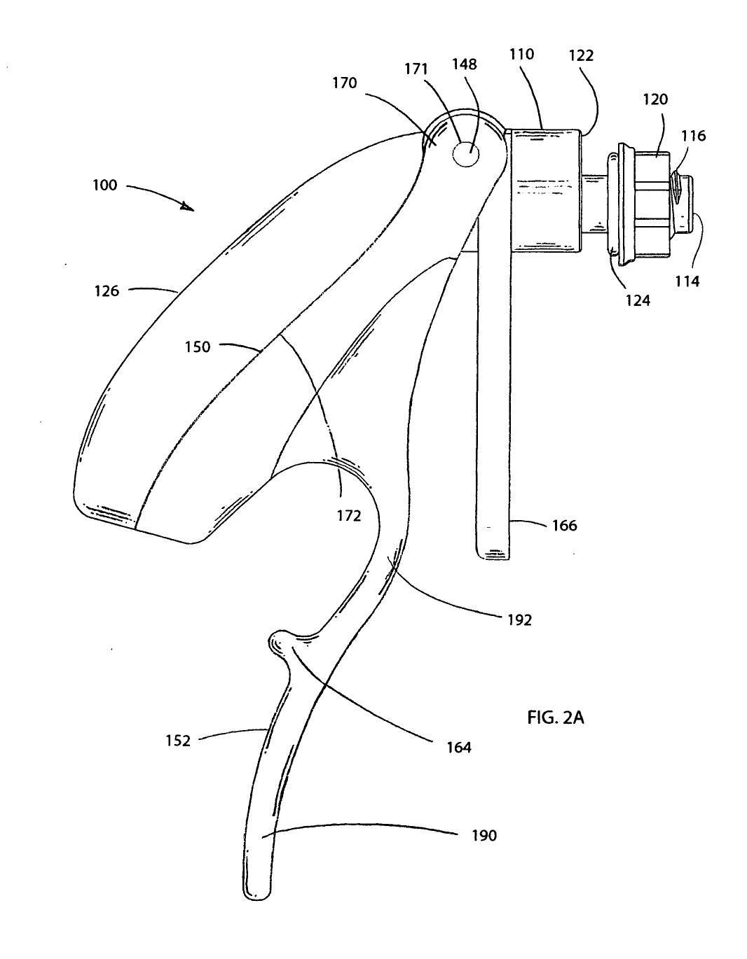

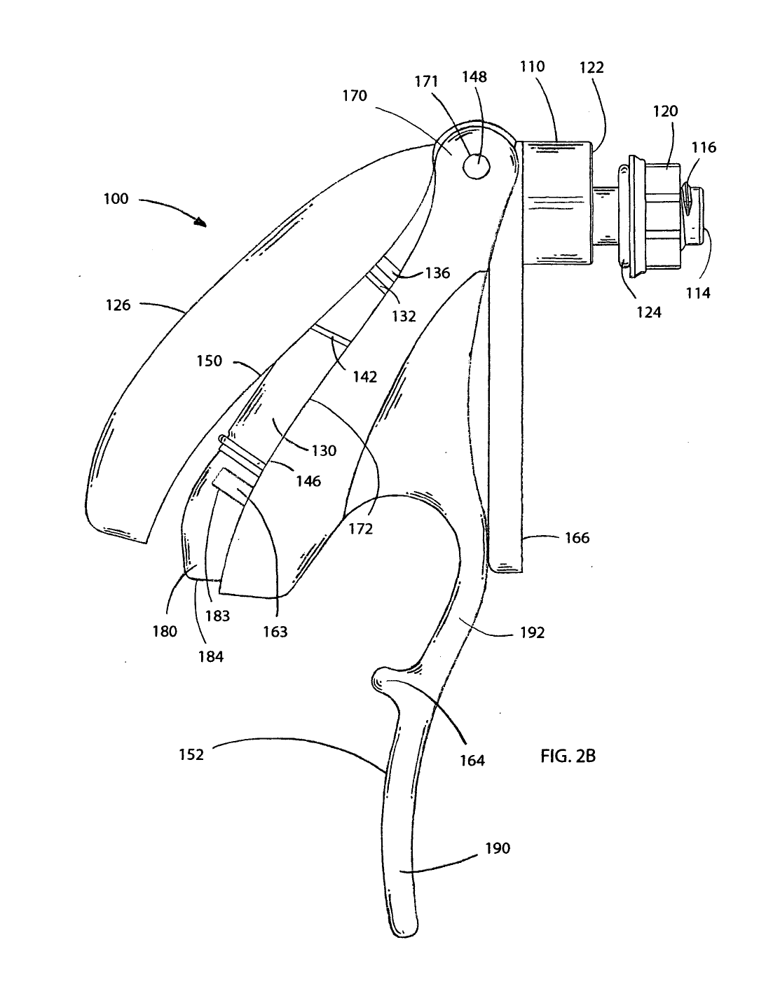

As shown in FIGS. 2A and 4A, when closure element 142 biases actuator lever 152 to the closed position, conduit 130 is pinched between flange contact area 139 and flange contact area 156 and the flow of liquid through spigot 100 is stopped. As shown in FIGS. 2B and 4B, the spigot is in the open position when actuator lever 152 rotates towards container 104 until actuator stem 192 comes into contact with tab 166. In the open position, flange contact area 156 is separated from flange contact area 139, allowing conduit 130 to open and liquid to flow through the spigot.

Although the description above contains many specificities, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

### ADVANTAGES

From the detailed description of one embodiment of the disclosed spigot above, a number of advantages of the spigot become evident as compared to known spigots:

(a) The disclosed spigot can be more easily operated by a user using only the hand in which they are holding the cup or personal beverage container they intend to fill. This allows the user to use their other hand to hold items such as plates at a picnic, a tennis racquet, a golf club, or another cup or container at a sporting event.

(b) The maximum flow rate of the disclosed spigot is greater because there are no obstructions in the flow path of the liquid through the spigot when the spigot is fully opened.

(c) The rate of flow through the disclosed spigot can be more easily and finely controlled because the actuator lever travels farther from its open position to the closed position than push-button actuators on known spigots. This allows users to fill their cups or personal beverage containers as quickly or as slowly as they like, and to reduce the flow rate in a controlled and deliberate manner to fill their container to the top without overfilling.

(d) The disclosed spigot can be more easily cleaned and disinfected, and more thoroughly dried, because all of the internal surfaces of the fluid conduits inside the spigot are easily accessible and there are no voids or hidden reservoirs. Thus, the spigot can be cleaned and disinfected using a dishwasher, common bottle brushes, or other common cleaning methods or apparatuses, and will dry thoroughly and completely with or without manual drying.

(e) The disclosed spigot can be operated more easily by people with limited finger strength or people with physical or neuromuscular disorders because a user does not need to use their fingers to operate the spigot. Any user that can hold a cup or personal beverage container in one of their hands can use the disclosed spigot to fill that container without any part of their body coming in contact with the spigot.

What is claimed is:

1. A spigot comprising:
a rigid first conduit in fluid flow communication with a container;
a rigid shroud attached to the first conduit;
a flexible second conduit in fluid flow communication with said first conduit and located internal to said shroud;
a first flange formed in said shroud perpendicular to the longitudinal axis of the second conduit;
an actuator lever connected directly to said first conduit having a second flange extending therefrom, said actuator lever being pivotable about a horizontal axis and moveable with respect to said first conduit between a closed position in which said second flange compresses said second conduit against said first flange to prevent liquid from flowing through said second conduit, and an open position in which said second flange is separated from said first flange to allow liquid to flow through said second conduit;
a closure element urging said actuator lever to said closed position; and
a third conduit in fluid flow communication with said second conduit, said third conduit attached to said actuator lever.

2. The spigot of claim 1, wherein said actuator lever extends vertically below said third conduit and is positioned a predetermined distance horizontally behind said third conduit such that liquid, when discharged through said third conduit, will communicate directly into a personal beverage container located below said third conduit and in contact with said actuator lever.

3. The spigot of claim 1, further comprising an elongated tab of rigid material extending downward vertically from said first conduit and located at a predetermined position behind said actuator lever to stop the movement of said actuator lever at said open position and to ensure the unimpeded movement of said actuator lever between the closed position and the open position.

4. The spigot of claim 1, wherein said first conduit and said shroud are formed as a single continuous part.

5. The spigot of claim 1, wherein said second conduit and said third conduit are formed as a single continuous part.

6. The spigot of claim 1, further characterized by said actuator lever comprising an indexing ridge or similar means for guiding the proper positioning of said personal beverage container against said actuator lever.

7. A liquid dispensing device comprising:
a container having a vertical sidewall;
a rigid first conduit in fluid flow communication with a container;
a rigid shroud attached to the first conduit;
a flexible second conduit in fluid flow communication with said first conduit and located internal to said shroud;
a first flange formed in said shroud perpendicular to the longitudinal axis of the second conduit;
an actuator lever connected directly to said first conduit having a second flange extending therefrom, said actuator lever being pivotable about a horizontal axis and moveable with respect to said first conduit between a closed position in which said second flange compresses said second conduit against said first flange to prevent liquid from flowing through said second conduit, and an open position in which said second flange is separated from said first flange to allow liquid to flow through said second conduit;
a closure element urging said actuator lever to said closed position; and
a third conduit in fluid flow communication with said second conduit, said third conduit attached to said actuator lever.

8. The device of claim 7, wherein said actuator lever extends vertically below said third conduit and is positioned a predetermined distance horizontally behind said third conduit such that liquid, when discharged through said third conduit, will communicate directly into a personal beverage container located below said third conduit and in contact with said actuator lever.

9. The device of claim 7, further comprising an elongated tab of rigid material extending downward vertically from said first conduit and located at a predetermined position behind said actuator lever to stop the movement of said actuator lever at said open position and to ensure the unimpeded movement of said actuator lever between the closed position and the open position.

10. The device of claim 7, wherein said first conduit and said shroud are formed as a single continuous part.

11. The device of claim 7, wherein said second conduit and said third conduit are formed as a single continuous part.

12. The device of claim 7, further characterized by said actuator lever comprising an indexing ridge or similar means for guiding the proper positioning of said personal beverage container against said actuator lever.
